(19) United States
(12) Patent Application Publication
(10) Pub. No.: US 2006/0036455 A1
(43) Pub. Date: Feb. 16, 2006

(54) Method and apparatus for dynamically reconfiguring views for business information monitors

(75) Inventors: Vani Prasad, Austin, TX (US); Daniel R. Roth, Somerville, MA (US); William Raul Salinas, Richmond, VA (US); William Streit, Durham, NC (US); Scott Winters, Austin, TX (US)

Correspondence Address: IBM CORPORATION (CS);C/O CARR LLP, 670 FOUNDERS SQUARE, 900 JACKSON STREET, DALLAS, TX, 75202, US

(73) Assignee: International Business Machines Corporation, Armonk, NY (US)

(21) Appl. No.: 10/916,979

(22) Filed: Aug. 12, 2004

(51) Int. Cl. G06Q 99/00

(52) U.S. Cl. 705/1

(57) ABSTRACT

The present invention provides a method for dynamically reconfiguring views for business information dashboards. A dashboard is connected to an intelligent backend, which is also connected to the business information sources. A user can supply the intelligent backend with priority data about which information is to be displayed. The intelligent backend processes the data from the business sources, and determines the views to be shown by the dashboard.

### TECHNICAL FIELD

The invention relates generally to business information software and, more particularly, to dynamically reconfiguring views for business information monitors.

### BACKGROUND

In the fast-paced world of modern business, it is critical for business managers to have up-to-date information integrated from a variety of sources at their fingertips. For example, if an electric power company undergoes a disruption in transmission, it might gather information from customer calls, check its data base of customers for the location of the outage, check its manpower system to schedule workers and check its work management system to arrange equipment to repair the outage. If an independent power generator loses capacity and market price is high, the company must be careful not to sell more power than it can generate.

Businesses use business information (BI) software to integrate the data from a variety of sources, such as data bases, workforce management, sales, profit and loss, billing, payroll, receivables, and customer relations management. The main display for the business information software, a business information monitor or dashboard by analogy to the dashboard of an automobile, displays a variety of indicators, or gauges, about the business. Because the information available is more than will fit on the dashboard, the set of gauges displayed at a given time is only a subset of the gauges available. A problem with the business information dashboard is that the set of gauges displayed is fixed, and thus the kinds of information displayed by the dashboard are fixed. The gauges on display may not provide the most significant information about the current state of the business. For example, the kinds of information displayed during an emergency may not be the gauges relevant to the emergency. Further, the display does not cover the full range of information about the business over time.

A dashboard can flash a warning in case of an emergency. The warning is an add-on, not part of the usual display. The display does not generally provide the information needed to react to the emergency. Further, the warning is generated when an indicator exceeds a fixed threshold value. If the threshold is set too high, emergencies will occur without warning. If the threshold is set too low, the user will be plagued with false warnings. Finally, the warning does not inform the user of important, but non-emergency, situations.

Dashboard gauges can aggregate all of the data from the business into high-level statistics. These high-level statistics are difficult to understand. The user must mine the data manually to obtain greater detail. Further, an emergency affecting one aspect of a company may not cause enough change in the over-all picture to make a noticeable change to the aggregate data.

What is needed is a business information dashboard with greater variability in the fields of information shown. The business information dashboard displays the most important information at the moment. In particular, when an emergency arises, the dashboard displays data describing the situation related to the emergency. Further, over time the dashboard display can run over the full range of sources of information for the business.

### SUMMARY OF THE INVENTION

The present invention provides a method for dynamically reconfiguring views for business information dashboards. A dashboard is connected to an intelligent backend, which is also connected to the business information data sources. The intelligent backend processes the data from the business sources, and determines the views to be shown by the dashboard.

### BRIEF DESCRIPTION OF THE DRAWINGS

For a more complete understanding of the present invention, and the advantages thereof, reference is now made to the following Detailed Description taken in conjunction with the accompanying drawings, in which:

FIG. 1 schematically depicts a system for dynamically reconfiguring views for business information dashboards; and

FIG. 2 provides pseudo-code for an algorithm to determine a view to be displayed by a business information dashboard.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein can be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

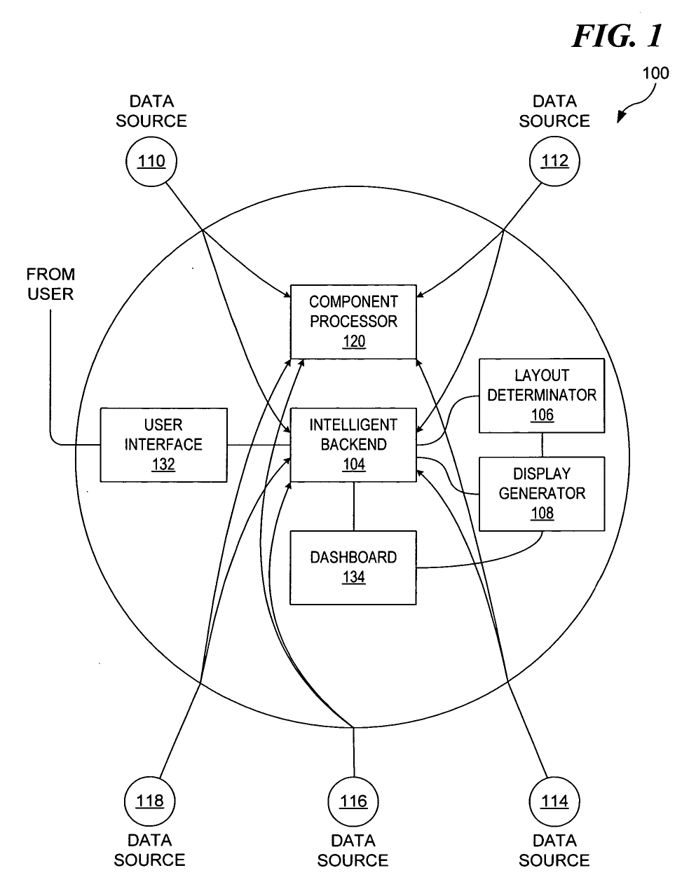

Turning to FIG. 1, schematically depicted is a system of business information software 100 for dynamically reconfiguring views for business information monitors or dashboards. The business information software 100 integrates data from a plurality of data sources 110, 112, 114, 116 and 118. Data from the data sources 110, 112, 114, 116 and 118 is passed to the intelligent backend 104. The data from the data sources 110, 112, 114, 116 and 118 is also passed to the component processor, which transforms the data into individual visual components. In portal terminology, the component processor creates individual portlets.

The dashboard 134 displays a collection of the individual visual components. There are more individual visual components than can be displayed at any one time. The collection of individual visual components on display is defined as the view. An individual visual component could be a metric. A gauge can be associated with the metrics. In that case, the view is a set of gauges.

The user also passes criteria for the selection of views to the intelligent backend 104 through the user interface 132. Processing the user-supplied criteria and the data from the plurality of data sources 110, 112, 114, 116 and 118, the intelligent backend 104 determines the views to be displayed by the dashboard 134.

The intelligent backend 104 can use a variety of mechanisms to determine the views to be displayed. It can use the artificial intelligence techniques of rule-based or case-based reasoning. It can use formulas. For example, it can rank the different data sources by the percentage of deviation from goal. It can contain a set of views to be displayed in a variety of scenarios. For example, when a particular kind of emergency occurs, the proper set of data to deal with the emergency will be displayed. The intelligent backend can be programmed so that the views on display cover the entire set of data sources over time, or cover the entire set absent an emergency. Thus, the display provides a complete picture of business over time.

The intelligent back end 104 can incorporate machine-learning technology or other technology so that its algorithm for the selection of views changes over time. For example, a certain threshold value for a metric may indicate that the individual visual component associated with the metric should be displayed. If, over time, the metric never approaches that threshold value, the intelligent back end 104 can modify the threshold value, so that the associated individual visual component should be displayed when the metric reaches a lower value. Similarly, by observing what views the user chooses to display under what circumstances, the intelligent back end 104 can display those views in similar circumstances.

The format in which the user provides criteria for the selection of views to the intelligent backend 104 depends upon the mechanism used by the intelligent backend 104. For example, if the intelligent backend 104 operates in part as a rule-based mechanism, the user interacts with the intelligent backend 104 through the user interface 132 to formulate a suitable collection of rules. If the intelligent backend 104 operates in part as a case-based mechanism, the user interacts with the intelligent backend 104 through the user interface 132 to generate a suitable set of cases. If the intelligent backend 104 operates in part through the use of formulas, the user interacts with the intelligent backend 104 through the user interface 132 to generate a suitable set of formulas.

In one alternative embodiment, the display on the dashboard 134 cycles through a complete set of individual visual components over time. The user interacts with the intelligent backend 104 through the user interface 132 to input a suitable set of parameters to describe to the intelligent backend 104 how to combine the current importance of the data contained in an individual visual component and the lag since the last display of the individual visual component into an overall rating of the value of the display of the individual visual component.

The intelligent backend 104 passes the data fields to be displayed to the layout determiner 106. The layout determiner 106 creates a layout or template for the display of the individual visual components of the data fields. The layout could be in the form of a dynamically generated template.

The layout determiner 106 passes the layout or template to the display generator 108. The display generator 108 uses the layout or template, and the individual visual components of the selected fields produced by the component processor to create the overall display. For example, with a portal server, the template from the layout determinator would be used to arrange the individual visual components or portlets on the page according to the layout or template.

The system 100 automatically displays to the user the most important current data in accordance with criteria specified by the user. The intelligent backend 104 rates the importance of the different individual visual components at a given time according to the user-specified criteria, and selects the most important data fields. Those data fields are then displayed by the dashboard 108. In an alternative embodiment where the algorithm of the intelligent backend 104 for the selection of views changes over time, the intelligent back end 104 rates the importance of the different individual visual components at a given time according to its current algorithm.

As a result, the user does not miss an important event because the display is showing another aspect of a business. The user does not need to manually go into the system to rotate through various views to determine if some other view provides more important information. The system automatically displays the most important view. Finally, the user can get a complete picture of the business over time without having to change the view, if the user so desires. By including in the criteria for selecting the display a lag-time factor, individual visual components that have not been seen for the longest time will be preferred for some segment of time. Thus, over the course of time, the display will rotate over all individual visual components, unlike the current state of the art.

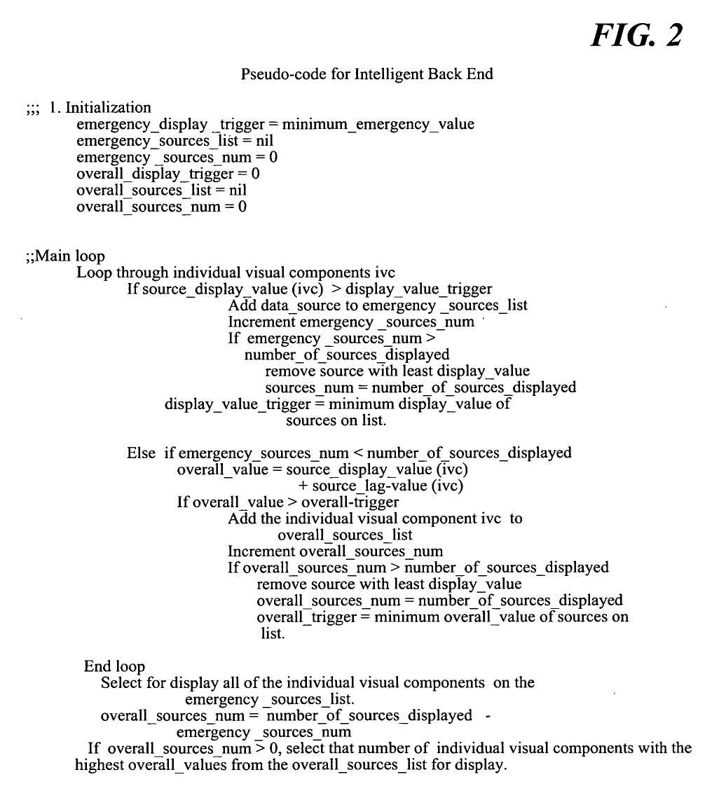

FIG. 2 gives pseudo-code for an algorithm to determine the individual visual components to be displayed by the business information dashboard 134 in one alternative embodiment. The selection of individual visual components is based on a combination of the sum of their current display value and their lag display value, a component to measure the value of displaying the individual visual components that have not been displayed for some time. If a current display value is critical (an emergency situation), the individual visual component is displayed regardless of its lag display value.

In this alternative embodiment, the intelligent backend 104 first initializes variables. It sets the emergency_display_trigger to the minimum emergency display value, the minimum value for an emergency. The intelligent backend 104 also sets the emergency_data_sources to NIL, the overall_display_trigger to 0, and the overall_display_sources to NIL.

Next, the intelligent backend 104 loops through the individual visual components for the business information software. For each individual visual component, the intelligent backend 104 applies the relevant criterion to calculate the display value of the individual visual component under the criterion. If the display value is higher than the emergency_display_trigger, then the intelligent backend 104 adds this individual visual component to the emergency_data_sources. If there are more individual visual component in emergency_data_sources than can be displayed, the intelligent back end 104 removes the individual visual component with the least display value, and sets the emergency_display_trigger to the lowest display value of the remaining sources in emergency_data_sources.

If the display value is less than the emergency_display_trigger and the emergency sources are less than can be displayed, the intelligent backend 104 determines the overall display value of the individual visual component by adding the delay value to the display value. If the overall value is higher than the overall_display_value, the intelligent backend 104 adds the individual visual component to the overall_display_sources. If the total sources in the emergency_data_sources and overall_display_sources are more than can be displayed, the intelligent back end 104 removes the individual visual component with the lowest overall display value from the overall_display_sources and sets the overall_display_trigger to the lowest display value of the remaining sources in overall_data_sources.

After going through all the individual visual components, the algorithm will have selected the most important individual visual components to display in the current situation, taking into account both the value of the display of each individual visual component and the lag value of each individual visual component. Further, the algorithm will select for display the individual visual components relevant to emergency situations, unless there are more individual visual components than can be displayed. In that case, the algorithm will select the most important individual visual components.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A system of business information software for dynamically reconfiguring views for business information dashboards comprising:
a dashboard;
an interface to data sources; and
an intelligent backend coupled to the dashboard and the interface to data sources, the intelligent backend configured so that, responsive to data from the data sources, the intelligent backend determines a data field to be displayed by the dashboard.

2. The system of claim 1, wherein the dashboard displays the data field determined by the intelligent back end.

3. The system of claim 1, further comprising a user interface connected to the intelligent backend, the user interface configured to receive information about the determination of the data fields to be displayed by the dashboard, wherein the intelligent back end is further configured to determine the data fields to be displayed by the dashboard, responsive to the received information.

4. The system of claim 1, wherein the intelligent backend is further configured so that the lag since the last time the data in a data field was displayed is a factor in determining the data fields to be displayed.

5. The system of claim 1, wherein the intelligent backend is further configured to use rule-based reasoning in determining the data fields to be displayed.

6. The system of claim 1, wherein the intelligent backend is further configured to use case-based reasoning in determining the data fields to be displayed.

7. The system of claim 1, wherein the intelligent backend is further configured to use formulas in determining the data fields to be displayed.

8. A method for dynamically reconfiguring views for a dashboard of business information software comprising:
monitoring the data from a plurality of data sources passing to the business information software; and
determining the views to be shown by the dashboard of the business information software, responsive to the data from the plurality of data sources passing to the business information software.

9. The method of claim 8, further comprising the step of inputting information to the business information software about the determination of the views to be shown by the dashboard, wherein the views shown by the dashboard are responsive to the inputted information.

10. The method of claim 8, wherein the lag since the last time the data from one of the plurality of data sources was displayed is a factor in determining the views to be shown by the dashboard.

11. The method of claim 8, wherein rule-based reasoning is used in determining the dashboard views.

12. The method of claim 8, wherein case-based reasoning is used in determining the dashboard views.

13. The method of claim 8, wherein formulas are used in determining the dashboard views.

14. Computer program product for dynamically reconfiguring views for a dashboard of business information software, the computer program product having a medium with a computer program embodied thereon, the computer program comprising:
computer code for monitoring the data from a plurality of data sources passing to the business information software; and
computer code for determining the views to be shown by the dashboard of the business information software, responsive to the data from the plurality of data sources passing to the business information software.

15. The computer program product of claim 14, further comprising computer code for inputting information to the business information software about the determination of the views to be shown by the dashboard, wherein the views shown by the dashboard are responsive to the inputted information.

16. The dcomputer program product of claim 14, wherein the lag since the last time the data from one of the plurality of data sources was displayed is a factor in determining the views to be shown by the dashboard.

17. The computer program product of claim 14, wherein case-based reasoning is used in determining the dashboard views.

18. The computer program product of claim 14, wherein rule-based reasoning is used in determining the dashboard views.

19. The computer program product of claim 14, wherein formulas are used in determining the dashboard views.

20. A processor for dynamically reconfiguring views for a dashboard of business information software, the processor including a computer program comprising:
computer code for monitoring the data from a plurality of data sources passing to the business information software; and
computer code for determining the views to be shown by the dashboard of the business information software, responsive to the data from the plurality of data sources passing to the business information software.
